(19) United States
(12) Patent Application Publication
(10) Pub. No.: US 2026/0244656 A1
(43) Pub. Date: Aug. 20, 2026

(54) INFORMATION PROCESSING DEVICE, INFORMATION PROCESSING METHOD, AND NON-TRANSITORY COMPUTER READABLE MEDIUM

(71) Applicant: NEC Corporation, Tokyo (JP)

(72) Inventors: Daichi IWATA, Tokyo (JP); Ryo KATO, Tokyo (JP); Kai ISHIKAWA, Tokyo (JP); Katsuma HORINO, Tokyo (JP)

(73) Assignee: NEC Corporation, Tokyo (JP)

(21) Appl. No.: 19/530,498

(22) Filed: Feb. 5, 2026

(30) Foreign Application Priority Data
Feb. 18, 2025 (JP) 2025-024371

(51) Int. Cl. G06F 16/3329; G06F 40/186

(52) U.S. Cl. CPC G06F 16/33295; G06F 40/186

(57) ABSTRACT

An object is to contribute to improve a technology for automatically generating an interview record. An information processing device includes a prompt generation unit that generates a prompt for instructing to generate an interview record, reflecting related information regarding a target interview and a generation control unit that inputs the prompt to a machine-learned generative model and causes the generative model to generate the interview record of the target interview. The generated interview record is suitably used for decision making based on content of the target interview or the like.

### INCORPORATION BY REFERENCE

This application is based upon and claims the benefit of priority from Japanese patent application No. 2025-024371, filed on February 18, 2025, the disclosure of which is incorporated herein in its entirety by reference.

### TECHNICAL FIELD

The present disclosure relates to an information processing device, an information processing method, and an information processing program.

### BACKGROUND ART

A technique for supporting creation of an interview record in various interviews has been known. For example, JP 2023-20997 A below describes a report creation support device including an important matter setting unit that sets a plurality of important matters that are important matters in an interview and an important matter acquisition unit that acquires each set important matter from the recorded interview.

### SUMMARY

Here, in a case where a person creates an interview record, the interview record is created in consideration of various pieces of related information, such as a participant of an interview, a background to the interview, a subject of the interview, peripheral information regarding these, in addition to important matters of the interview. However, a report creation support device in JP 2023-20997 A only acquires the important matters set for the interview. That is, the report creation support device in JP 2023-20997 A has room for improvement in that it is not possible to generate the interview record in consideration of various types of related information.

The present disclosure has been made in view of the above problems, and an example object is to contribute to improve a technology for automatically generating an interview record.

An information processing device according to an example aspect of the present disclosure includes prompt generation means for generating a prompt for instructing to generate an interview record, reflecting related information, using the related information regarding a target interview of which the interview record is generated and generation control means for inputting the prompt to a generative model that generates the interview record according to an input instruction and causing the generative model to generate the interview record of the target interview.

In an information processing method according to an example aspect of the present disclosure, at least one processor executes prompt generation processing for generating a prompt for instructing to generate an interview record, reflecting related information, using the related information regarding a target interview of which the interview record is generated and generation control processing for inputting the prompt to a generative model that generates the interview record according to an input instruction and causing the generative model to generate the interview record of the target interview.

An information processing program according to an example aspect of the present disclosure causes a computer to function as prompt generation means for generating a prompt for instructing to generate an interview record, reflecting related information, using the related information regarding a target interview of which the interview record is generated and generation control means for inputting the prompt to a generative model that generates the interview record according to an input instruction and causing the generative model to generate the interview record of the target interview.

According to one exemplary aspect of the present disclosure, an exemplary effect is achieved that it is possible to contribute to improve a technology for automatically generating an interview record.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing device according to the present disclosure;

FIG. 2 is a flowchart illustrating a flow of an information processing method according to the present disclosure;

FIG. 3 is a block diagram illustrating a configuration of another information processing device according to the present disclosure;

FIG. 4 is a diagram illustrating a generation example of an interview record;

FIG. 5 is a diagram illustrating another generation example of the interview record;

FIG. 6 is a flowchart illustrating an example of processing executed by the information processing device illustrated in FIG. 3; and

FIG. 7 is a block diagram illustrating a configuration of a computer that functions as the information processing device according to the present disclosure.

### EXAMPLE EMBODIMENTS

Hereinafter, example embodiments of the present disclosure will be exemplified. However, the present disclosure is not limited to the following exemplary example embodiments, and various modifications may be made within the scope described in the claims. For example, example embodiments obtained by appropriately combining techniques (some or all of objects or methods) adopted in the following exemplary example embodiments may fall within the scope of the present disclosure. Example embodiments obtained by appropriately omitting some of the techniques adopted in the following exemplary example embodiments may also fall within the scope of the present disclosure. Effects mentioned in the following exemplary example embodiments are examples of effects expected in the exemplary example embodiments, and do not define extension of the present disclosure. That is, example embodiments that do not exert the effects mentioned in the following exemplary example embodiments may also fall within the scope of the present disclosure.

### First Exemplary Example Embodiment

A first exemplary example embodiment, which is an example of the example embodiments of the present disclosure, will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in the drawings referred to for describing the present exemplary example embodiment can also be adopted in other exemplary example embodiments included in the present disclosure within a range in which no particular technical problem occurs.

### Configuration of Information Processing Device 1

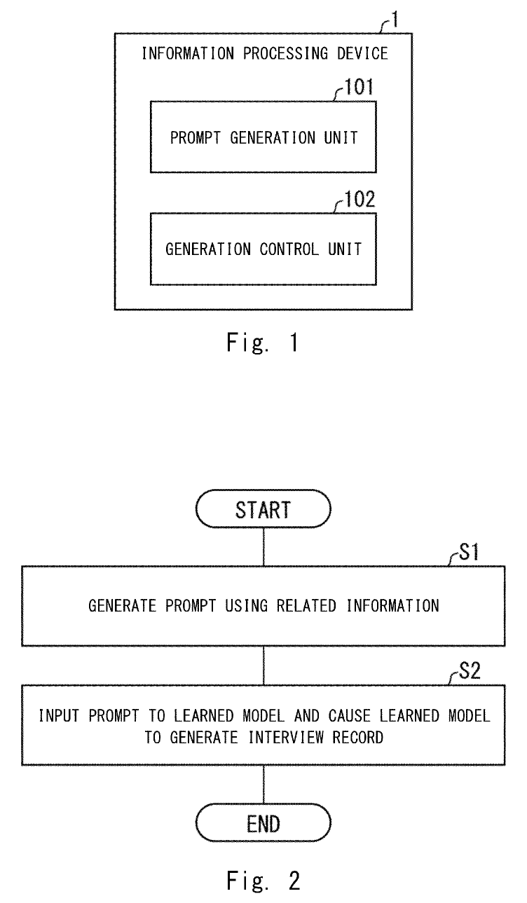

A configuration of an information processing device 1 according to the present exemplary example embodiment will be described with reference to FIG. 1. FIG. 1 is a block diagram illustrating the configuration of the information processing device 1. As illustrated in FIG. 1, the information processing device 1 includes a prompt generation unit 101 and a generation control unit 102.

The prompt generation unit 101 generates a prompt for instructing to generate an interview record, reflecting related information, using the related information regarding a target interview of which an interview record is generated. Here, the “interview” means a dialogue performed by a plurality of participants, and those that involve a dialogue among a consultation, a conference, a meeting, a dialogue, a counseling, an examination by a doctor or the like, an interview, and the like are also included in the scope of the interview. The participants in the interview may include participants other than humans such as chatbots (those who are not human but participate in the dialogue in the interview are referred to as “participants”).

In addition, the “interview record” is a record recording content of the dialogue in the interview, and can be also rephrased to as a dialogue record or the like. In addition, the interview record can also be rephrased as, for example, meeting minutes in a case where the target interview is a conference or a meeting, a medical record in a case where the target interview is a counseling or an examination, an interview record in a case where the target interview is an interview, or the like.

The “prompt” indicates content of an instruction (can be rephrased to as command, demand, request, or the like) to a generative model to be described later. By inputting the prompt to the generative model, the generative model generates content according to the instruction indicated by the prompt.

It is sufficient that the “related information” be any information as long as it is related to the target interview to some extent. For example, the related information may be information indicating at least any one of matters to be included in the interview record, a participant of the target interview, a purpose of the target interview, a background to the target interview, and a subject of the target interview. In addition, for example, the related information can be information indicating the number of times of interviews, an interview date and time, or the like. The prompt reflecting the related information means a prompt that directly or indirectly includes content of the related information. For example, the prompt generation unit 101 may generate a prompt including the related information as it is or may generate a prompt including a sentence or the like generated using the related information.

The generation control unit 102 inputs the prompt generated by the prompt generation unit 101 to the generative model that generates the interview record according to the input instruction and causes the generative model to generate the interview record of the target interview.

The interview record generated by the generative model may be, for example, text data in which content of an interview is described as a text. The interview record generated by the generative model may include data in a format other than text such as a still image, a moving image, or voice. The interview record generated by the generative model does not necessarily need to be an interview record in a completed form and may be a part of the interview record in the completed form (for example, description about some of plurality of items included in interview record). In this case, the generation control unit 102 may cause the generative model to generate each portion of the interview record in the completed form and generate the interview record in the completed form by combining the interview records generated from the respective portions.

It is sufficient that the “generative model” be a machine-learned model that generates the interview record according to the input instruction. The generative model may be a model generated for generating an interview record, or may be a general-purpose model that can be used for applications other than the generation of the interview record. The generative model may be a model obtained by fine-tuning a general-purpose model for generating an interview record. For example, a Generative Pre-trained Transformer (GPT) model obtained by machine learning of a natural language, a Bidirectional Encoder Representations from Transformers (BERT) model obtained by machine learning of a natural language, or the like can also be used as the generative model. In a case where the generative model that has machine-learned the natural language is used, it is sufficient for the prompt generation unit 101 to generate a prompt described in the natural language. In this case, the prompt generation unit 101 can include related information described in the natural language in the prompt as it is.

For example, in a case where the general-purpose model is used, a search based method can be adopted for searching for and referring to related information from a database such as past interview records or operational manuals. Specifically, in a case where the target interview is a financial product sales interview, the generation control unit 102 may search for past similar interview records, explanatory materials regarding the product, compliance requirements, or the like, based on a product name included in the prompt, an attribute of a customer who is other party of the interview, or the like. Then, in a case of causing the generative model to generate the interview record of the target interview, the generation control unit 102 can cause the generative model to refer to the information and generate a new interview record.

A prompt engineering technique for optimizing a structure and content of a prompt may be combined. For example, in a case where the target interview is a foreign bond sales interview, the generation control unit 102 can automatically add a sentence for instructing to always describe an explanation status of a foreign exchange risk to the prompt or include an instruction for adjusting a use level of a technical term according to an investment experience of the customer, in the prompt. As a result, it is possible to generate an interview record completely including necessary elements according to a type or a situation of the interview.

As described above, the interview record may include the data in the format other than the text. In a case where the data in the format other than the text is included in the interview record, it is sufficient to use a model for generating content in the format other than the text, as the generative model. For example, the generation control unit 102 can generate an interview record including an image generated by a generative model, by using the generative model such as DALL-E for generating an image based on text description.

As described above, the information processing device 1 according to the present exemplary example embodiment adopts a configuration including the prompt generation unit 101 that generates the prompt for instructing to generate the interview record, reflecting the related information, using the related information regarding the target interview of which the interview record is generated and the generation control unit 102 that inputs the prompt generated by the prompt generation unit 101 to the generative model that generates the interview record according to the input instruction and causes the generative model to generate the interview record of the target interview.

According to the above configuration, the prompt reflecting the related information is generated using the related information, and the interview record is generated by inputting the generated prompt to the generative model. As a result, it is possible to automatically generate the interview record reflecting the related information. Therefore, according to the above configuration, an effect can be obtained that it is possible to improve a technology for automatically generating the interview record. The generated interview record can be suitably used, for example, for decision making based on the content of the target interview, or the like.

### Information Processing Program

The functions of the information processing device 1 described above can be achieved by a program. An information processing program according to the present exemplary example embodiment causes a computer to function as prompt generation means for generating a prompt for instructing to generate an interview record, reflecting related information, using the related information regarding a target interview of which the interview record is generated and generation control means for inputting the prompt generated by the prompt generation means to a generative model that generates the interview record according to the input instruction and causes the generative model to generate the interview record of the target interview. According to this information processing program, an effect can be obtained that it is possible to improve the technology for automatically generating the interview record.

### Flow of Information Processing Method

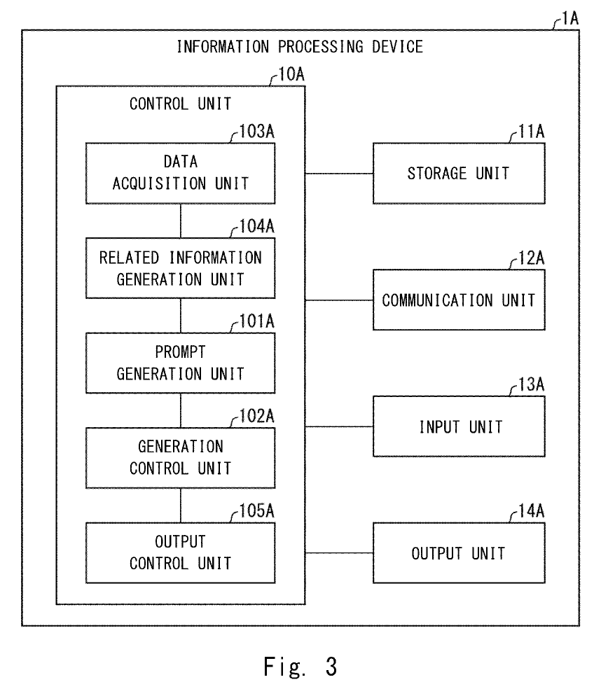

Next, a flow of an information processing method according to the present exemplary example embodiment will be described with reference to FIG. 2. FIG. 2 is a flowchart illustrating the flow of the information processing method. An executing entity of each step in this information processing method may be a processor included in the information processing device 1, may be a processor included in another device, or an executing entity of each step may be a processor provided in each of different devices.

In S1 (prompt generation processing), at least one processor generates the prompt for instructing to generate the interview record, reflecting the related information, using the related information regarding the target interview of which the interview record is generated.

In S2 (generation control processing), the at least one processor inputs the prompt generated in S1 to the generative model that generates the interview record according to the input instruction and causes the generative model to generate the interview record of the target interview.

As described above, the information processing method according to the present exemplary example embodiment adopts a configuration in which the at least one processor executes the prompt generation processing for generating the prompt for instructing to generate the interview record, reflecting the related information, using the related information regarding the target interview of which the interview record is generated and the generation control processing for inputting the prompt generated by the prompt generation processing to the generative model that generates the interview record according to the input instruction and causing the generative model to generate the interview record of the target interview. According to this information processing method, an effect can be obtained that it is possible to improve the technology for automatically generating the interview record.

### Second Exemplary Example Embodiment

A second exemplary example embodiment, which is an example of the example embodiments of the present disclosure, will be described in detail with reference to the drawings. Components having the same functions as the components described in the exemplary example embodiment described above will be denoted by the same reference signs, and description of the components will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within the scope in which no particular technical problem occurs.

### Configuration of Information Processing Device 1A

A configuration of an information processing device 1A according to the present exemplary example embodiment will be described with reference to FIG. 3. FIG. 3 is a block diagram illustrating the configuration of the information processing device 1A. The information processing device 1A is a device that has a function for generating an interview record.

As illustrated, the information processing device 1A includes a control unit 10A that integrally controls units of the information processing device 1A, and a storage unit 11A that stores various types of data to be used by the information processing device 1A. The information processing device 1A includes a communication unit 12A for the information processing device 1A to communicate with another device, an input unit 13A for accepting an input to the information processing device 1A, and an output unit 14A for the information processing device 1A to output data. Then, the control unit 10A includes a prompt generation unit 101A, a generation control unit 102A, a data acquisition unit 103A, a related information generation unit 104A, and an output control unit 105A.

Similarly to the prompt generation unit 101 in the first exemplary example embodiment, the prompt generation unit 101A generates a prompt for instructing to generate an interview record, reflecting related information, using the related information regarding a target interview of which the interview record is generated. A prompt generation method will be described later.

Similarly to the generation control unit 102 in the first exemplary example embodiment, the generation control unit 102A inputs the prompt generated by the prompt generation unit 101A to a generative model that generates the interview record according to the input instruction and causes the generative model to generate the interview record of the target interview. Hereinafter, the generative model caused to generate the interview record by the generation control unit 102A is referred to as a generative model 2A.

The data acquisition unit 103A acquires various types of data necessary for generating the interview record. For example, the data acquisition unit 103A acquires dialogue data indicating content of a dialogue in the target interview. The “dialogue data” only needs to indicate the content of the dialogue in the target interview. For example, voice data obtained by recording the dialogue in the target interview may be used as the dialogue data, or text data generated by performing voice recognition on the voice data may be used as the dialogue data. The voice recognition may be performed by the information processing device 1A or may be performed by another device. The data acquisition unit 103A may acquire the related information.

A method for acquiring data by the data acquisition unit 103A is not particularly limited, as long as a method according to data to be acquired or the like is applied. For example, the data acquisition unit 103A may acquire data input by a user of the information processing device 1A via the input unit 13A or may acquire data from another device through communication via the communication unit 12A.

The related information generation unit 104A generates the related information using the dialogue data acquired by the data acquisition unit 103A. The related information generated by the related information generation unit 104A is used to generate the prompt by the prompt generation unit 101A. Since the information processing device 1A includes the related information generation unit 104A, the information processing device 1A obtains an effect that it is possible to generate the interview record in consideration of the related information, without causing the user to input the related information, in addition to the effect of the information processing device 1. The information processing device 1A can generate the interview record using both of the related information input by the user and the related information generated by the related information generation unit 104A. A method for generating the related information will be described later.

The output control unit 105A causes an output device to output the interview record that the generation control unit 102A causes the generative model 2A to generate. The output device may be included in the information processing device 1A or may be an external device of the information processing device 1A. An output mode of the interview record may be a display output, a voice output, or a print output, and is not particularly limited. For example, the output control unit 105A may cause a display device to display output the interview record, may cause a voice output device to voice output the interview record, or may cause a printing device to print output the interview record.

As described above, similarly to the information processing device 1 according to the first exemplary example embodiment, the information processing device 1A according to the present exemplary example embodiment adopts a configuration including the prompt generation unit 101A that generates the prompt for instructing to generate the interview record, reflecting the related information, using the related information regarding the target interview of which the interview record is generated and the generation control unit 102A that inputs the prompt generated by the prompt generation unit 101A to the generative model 2A that causes the generative model 2A to generate the interview record according to the input instruction and generates the interview record of the target interview. Therefore, the information processing device 1A can also obtain an effect that it is possible to improve a technology for automatically generating the interview record.

### Method for Generating Related Information

As described above, the related information generation unit 104A generates the related information using the dialogue data acquired by the data acquisition unit 103A. For example, the related information generation unit 104A may estimate a predetermined matter regarding the target interview from the dialogue data, and generate related information indicating the estimation result. The “predetermined matter” only needs to be a matter related to the target interview, and is preferably a matter to be clarified in a case where the interview record is generated.

For example, in a case where the target interview is one of a series of interviews conducted a plurality of times, which one of the series of interviews the target interview corresponds to is the matter to be clarified in a case where an interview record having appropriate content is generated. Therefore, the related information generation unit 104A may estimate whether the target interview corresponds to any one of the series of interviews from the dialogue data and generate the related information indicating the estimation result. As a result, in addition to the effect obtained by the information processing device 1, an effect can be obtained that it is possible to generate the interview record based on which one of the series of interviews the target interview corresponds to.

For example, if the series of interviews relates to a business negotiation, the series of interviews may be classified into four stages including “A: unproposed”, “B: outline description”, “C: product proposal”, and “D: order/contract”. In this case, it is sufficient for the related information generation unit 104A to estimate which stage (can be rephrased as phase, step, or the like) the target interview corresponds to. It can be said that the estimation estimates a progress status of the series of interviews.

The method for estimating which one of the series of interviews the target interview corresponds to is not particularly limited. For example, the related information generation unit 104A may detect a predetermined phrase to be information for determining which one of the series of interviews the target interview corresponds to from the dialogue data and estimate which one of the series of interviews the target interview corresponds to, from the detected phrase. The predetermined phrase can be detected from the dialogue data, for example, using a technique such as Named Entity Recognition (NER).

As a specific example, in a case where the target interview is the business negotiation, it can be said that a phrase such as “we propose” included in the dialogue data suggests that the interview is at a stage where a product or the like is proposed. On the other hand, it can be said that a phrase such as “application” suggests that the interview is advanced to a stage of a contract. Therefore, various characteristic phrases at a product proposal stage such as “we propose” can be associated with the product proposal stage in advance, and various characteristic phrases at a product contract stage such as “application” can be associated with the product contract stage in advance. As a result, a rule base defining a relationship between utterance content and interview progress is constructed. Then, the related information generation unit 104A can detect the predetermined phrase from the dialogue data based on the rule base, specify which stage the phrase is associated with, and estimate that the specified stage is the stage of the target interview.

For example, the related information generation unit 104A may estimate the stage of the target interview, using an estimation model that estimates which one of the series of interviews the target interview corresponds to. As this estimation model, for example, the generative model 2A can be used, and another generative model or language model can be used. For example, the related information generation unit 104A generates the prompt by inputting the dialogue data to a portion of “xxx” in a template of “Please answer which stage the interview of the following dialogue data corresponds to. Dialogue data [xxx]”. Stage candidates: “A: unproposed”, “B: outline description”, “C: product proposal”, and “D: order/contract” and inputs the generated prompt to the generative model in such a way as to output an estimation result of the stage of the target interview.

The related information generation unit 104A may estimate a purpose of the target interview from the dialogue data and generate related information indicating the estimation result. As a result, in addition to the effect by the information processing device 1, an effect can be obtained that it is possible to generate the interview record based on the purpose of the target interview. In addition, for example, in a case where the target interview is the business negotiation, the related information generation unit 104A may estimate a target product, a type of the product, an interest or needs of a participant, important numerical value information such as a price or a period, or the like from the dialogue data. As a method for estimating these matters, a method similar to that in a case where the stage of the target interview is estimated can be applied.

### Prompt Generation Method

As described above, the prompt generation unit 101A generates the prompt reflecting the related information, using the related information regarding the target interview. A method for generating the prompt only needs to be a method that can generate the prompt reflecting the related information.

For example, the prompt generation unit 101A may generate the prompt reflecting the related information, based on a prompt for instructing to generate the interview record (hereinafter, referred to as basic prompt), commonly applicable to various interviews. In this case, the prompt generation unit 101A can generate the prompt reflecting the related information, by including content of the related information in the basic prompt.

For example, the basic prompt may be “Please generate an interview record of an interview having the following content. Please reflect the following related information in the interview record. Interview content [xxx]. Related information [yyy]”. In this case, the prompt generation unit 101A can generate the prompt reflecting the related information, by inputting the dialogue data to a portion of “xxx” in the basic prompt and inputting the related information to a portion of “yyy”.

The related information input to the portion of “yyy” may be, for example, speaker information indicating a speaker (can be rephrased to as participant) in the target interview, information indicating a voice tone of the speaker, or the like. Such information can be obtained by analyzing the dialogue data (original voice data, in a case where dialogue data is text data). The information processing device 1A or another device may analyze the dialogue data.

For example, in a case where the target interview is a business negotiation between a seller and a buyer, the related information input to the portion of “yyy” may be at least any one of various types of information regarding the seller, various types of information regarding the buyer, and various types of information regarding a product or a service recommended by the seller. Hereinafter, the “product or service” may be referred to as a “product or the like”.

Examples of the information regarding the seller include, for example, a department to which the seller belongs, qualifications (financial qualification such as sales representative, financial planner, or financial analyst in a case of financial product sales), information indicating a range of available products and services, or the like. In addition, for example, a name, an employee identification (ID), or the like of the seller may be the information regarding the seller. Such information is the related information regarding the target interview and can be referred to as attribute information indicating an attribute of the seller. The attribute information of the seller may be input by the user or may be estimated by the related information generation unit 104A from the dialogue data of the seller (may be past dialogue data) or the like.

Examples of the information regarding the buyer include a past transaction history of the buyer, and information indicating a stance or tendency at the time of purchasing a product or the like. In a case of a business negotiation of the financial product, a result of an analysis test regarding an investment such as a risk tolerance test or an investment style diagnosis test taken by the buyer may be the information regarding the buyer. In addition, for example, a name, a customer ID, or the like of the buyer may be the information regarding the buyer. Such information is the related information regarding the target interview and can be referred to as attribute information indicating an attribute of the buyer. Similarly to the attribute information of the seller, the attribute information of the buyer may be input by the user or may be estimated by the related information generation unit 104A from the dialogue data of the buyer or the like.

Examples of the information regarding the product or the like recommended by the seller include a name, classification, characteristics, or the like of the product or the like. For example, in a case where the seller recommends the financial product, information indicating whether the recommended financial product is a foreign bond, a domestic bond, an investment trust, or an insurance product may be used as the information regarding the product or the like. In this case, information regarding a price of the product (for example, unit price or minimum purchase price), a redemption period, an investment period, an interest payment period, an interest rate, a yield, a risk level, or the like may be used as the information regarding the product or the like. Such information may be input by the user or may be estimated by the related information generation unit 104A from the dialogue data or the like. Such information may be acquired from a database that stores the information regarding the product or the like.

As the information regarding the product or the like, information indicating a reaction pattern of another buyer with respect to the product or the like and information indicating a determination pattern (for example, purchase/not purchase, purchase amount if purchase, or the like) of the buyer in a case where the product or the like is purchased can be used. For example, text data such as “for this type of foreign bonds, 70% of buyers require detailed explanation about foreign exchange risk” can be used as the information regarding the product or the like. As a result, it is possible to generate an interview record based on that many buyers require the detailed explanation about the foreign exchange risk (for example, it is specified whether detailed explanation about foreign exchange risk has been made).

### About Generation of Template

For example, the prompt generation unit 101A may generate a template of the prompt using the related information. In this case, the prompt generation unit 101A generates the prompt using the generated template. As a result, in addition to the effect by the information processing device 1, an effect is obtained that it is possible to obtain a template that can be used for an interview similar to the target interview.

A method for generating the template is not particularly limited. For example, the prompt generation unit 101A may generate the template using the generative model that generates the template from the related information. As this generative model, the generative model 2A used to generate the interview record may be used, and a model different from the generative model 2A may be used. For example, the prompt generation unit 101A can generate the template reflecting the related information, by inputting the related information to the portion of “xxx” in the template of “The following related information is information regarding an interview. Please generate an instruction sentence for instructing to create an interview record in which a matter indicated by the related information is described. Related information [xxx]”, generating the prompt for instructing to generate the template, and inputting the generated prompt to the generative model.

For example, what template is generated for what related information may be defined as a rule in advance. In this case, the prompt generation unit 101A can generate the template according to the related information according to the rule.

### Another Example of Prompt Generation Method

How to reflect the related information in the interview record, according to the related information may be determined in advance. For example, an attribute of the participant of the target interview may be reflected in a style of the interview record. In this case, it is sufficient for the prompt generation unit 101A to generate a prompt for instructing to generate the interview record in a style suitable for the attribute, using related information indicating the attribute of the participant of the target interview. As a result, in addition to the effect by the information processing device 1, an effect is obtained that it is possible to generate the interview record in the style suitable for the attribute of the participant.

The “attribute” means a property belonging to the participant, and can be rephrased as characteristics, a property, a feature, or the like. The “style” means a style of writing or expression, and a level of detail of the description content or the like is included in the range of the style.

For example, in a case where the attribute of the participant indicated in the related information is “knowledge regarding financial product is poor”, it is sufficient for the prompt generation unit 101A to generate the prompt for instructing to generate the interview record in a style suitable for the attribute “knowledge regarding financial product is poor”. As a result, it is possible to generate an interview record in a style that is easy to understand for a person having poor knowledge regarding financial products (for example, technical term related finance is replaced with general term, description is added to technical term, or the like). On the other hand, it is possible to generate a detailed interview record using technical terms, as an interview record for a participant who has rich knowledge and experiences regarding the financial product. In addition, for example, it is possible to generate the interview record in a style according to an attribute such as a type of an investor (for example, psychological attribute such as aggressive type or safety-oriented type), a financial literacy level, or an age group.

The related information indicating the attribute of the participant can be generated by the related information generation unit 104A. For example, the related information generation unit 104A may input the dialogue data to the generative model, output an estimation result of the attribute of the participant, and use the estimation result as the related information. The dialogue data in this case does not necessarily need to be the dialogue data of the target interview and may be dialogue data of another interview in which the same participant participates.

The prompt generation unit 101A may generate a prompt for instructing to generate the interview record in a style preferred by the participant, based on a reaction of the participant to each interview record, for the participant who has participated in the plurality of interviews and has viewed the interview record of each interview. In this case, it is sufficient that the reaction of the participant be recorded as a reaction history and the data acquisition unit 103A acquire the recorded reaction history as the related information.

For example, the prompt generation unit 101A may generate the prompt for instructing to generate the interview record indicating an execution status of a predetermined response to be made in a case where the product or the service is recommended, using the related information indicating the product or the service recommended by the seller side in the target interview. As a result, in addition to the effect by the information processing device 1, an effect is obtained that it is possible to generate the interview record indicating the execution status of the predetermined response to be made in a case where the product or the service is recommended. Then, this makes it possible to easily confirm whether the predetermined response is executed at the time of the interview.

For example, in a case where a product recommended by the seller to the buyer is the financial product, the seller is obliged to provide necessary information such as a fee and a risk, to the buyer. Therefore, in a case where the related information indicating that the product or the service recommended by the seller side in the target interview is the financial product is acquired or generated, the prompt generation unit 101A may generate a prompt for instructing to generate an interview record indicating an execution status of explanation about the risk and the fee. This makes it possible to generate the interview record that makes it easy to confirm whether the above obligations have been fulfilled.

For example, the prompt generation unit 101A may generate a prompt for instructing to generate an interview record suitable for an application, using related information indicating the application of the interview record. As a result, in addition to the effect by the information processing device 1, an effect is obtained that it is possible to generate the interview record according to the application.

For example, in a case where the target interview is the business negotiation between the seller and the buyer, as the application of the interview record, an application for the participant of the interview such as an interview record for reference for the seller or an interview record for reference for the buyer is considered. In addition, for example, an application is considered such as an interview record used for response evaluation of the seller from the viewpoint of compliance or used as a business negotiation skill learning material. Then, according to such an application, content required for the interview record differs. By generating the prompt for instructing to generate the interview record suitable for the application indicated by the related information by the prompt generation unit 101A, it is possible to generate the interview record suitable for such various applications.

### Generation Example 1 of Interview Record

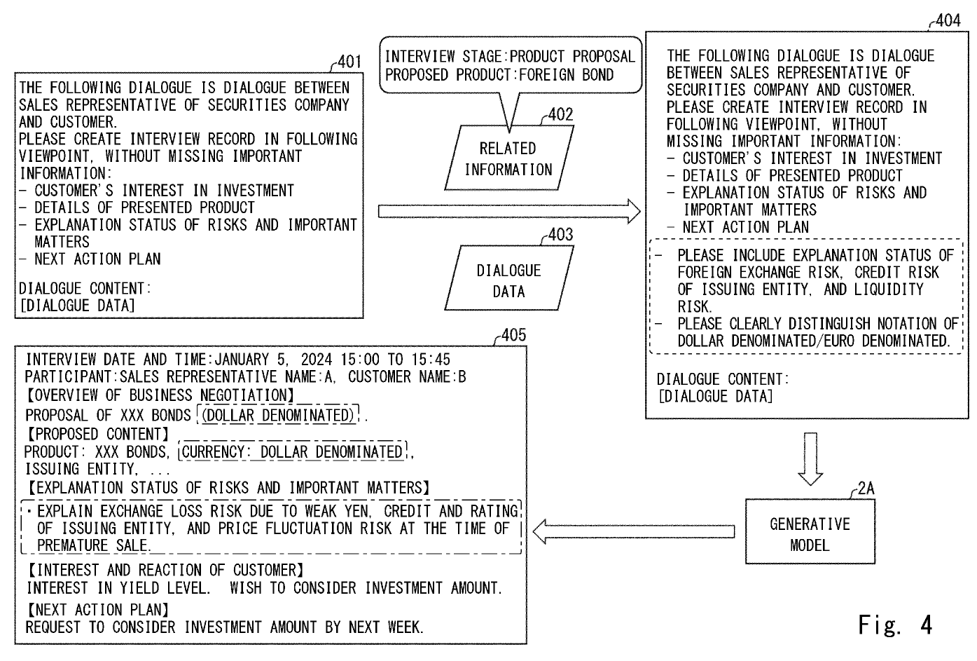

FIG. 4 is a diagram illustrating a generation example of the interview record by the information processing device 1A. In the example in FIG. 4, a prompt 404 is generated using a basic prompt 401, related information 402, and dialogue data 403. Then, the generated prompt 404 is input to the generative model 2A, and an interview record 405 is generated. The related information 402 is acquired by the data acquisition unit 103A or is generated by the related information generation unit 104A. The prompt 404 is generated by the prompt generation unit 101A, and the interview record 405 is generated by the generation control unit 102A.

The basic prompt 401 includes a sentence indicating that a sales representative of a securities company and a customer have a dialogue with each other in the target interview. In a case where the participant of the target interview is known, information indicating the participant may be included in the basic prompt in this way. Similarly, in a case where the purpose of the target interview or the like is known, such information may be included in the basic prompt. A plurality of types of basic prompts may be prepared in advance according to the purpose or the participant of the interview, and in that case, it is sufficient for the prompt generation unit 101A to select the basic prompt according to the target interview from among the plurality of types of basic prompts.

The basic prompt 401 includes a sentence for instructing to create the interview record, and a plurality of viewpoints to be considered in a case where the interview record is created is listed. In this way, the viewpoints to be considered in a case where the interview record is created may be included in the basic prompt. In particular, in a case where the purpose of the target interview, the application of the interview record, or the like is known, it is preferable that the viewpoint according to the purpose of the target interview, the application of the interview record, or the like be included in the basic prompt. For example, in a case where the target interview is an interview for the purpose of selling the financial product, as in the basic prompt 401, it is preferable that viewpoints such as customer’s interest in an investment, details of a presented product, an explanation status of risks and important matters, a next action plan, or the like be included in the basic prompt.

The basic prompt 401 includes a portion where dialogue content of the target interview is input. Specifically, the basic prompt 401 inputs the dialogue data 403 indicating the dialogue content of the target interview, to a portion of [dialogue data]. It can be said that the basic prompt 401 before the dialogue data 403 is input is a template of a prompt. As described above, such a template can be automatically generated using the generative model or the like.

The related information 402 illustrated in FIG. 4 indicates that the target interview is the interview at the product proposal stage and that the product proposed to the customer in the target interview is the foreign bond. As described above, such information can be estimated from the dialogue data or the like or may be input by the user via the input unit 13A or the like.

The prompt 404 generated using the related information 402 includes a new viewpoint that is not included in the basic prompt 401, as indicated by a dashed box in FIG. 4. More specifically, in response to the related information 402 indicating that the target interview is at the product proposal stage and the proposed product is the foreign bond, a viewpoint to be noted in the proposal of the foreign bonds is added to the prompt 404. Specifically, to the prompt 404, a viewpoint regarding the explanation status about the risk such as the foreign exchange risk and a viewpoint regarding clarification of description regarding currency are added.

The prompt generation unit 101A may cause the generative model (may be generative model 2A or another generative model) to generate a sentence in a portion surrounded by a broken line in the prompt 404. As a result, the related information 402 can be reflected in the prompt with a natural sentence. For example, the prompt generation unit 101A can generate a sentence reflecting the related information 402, by incorporating the related information 402 into a template prepared in advance. The prompt generation unit 101A may generate the prompt by incorporating the related information 402 into the basic prompt 401 as it is, without performing such processing.

As described above, the related information 402 is reflected in the prompt 404. Therefore, the related information 402 is reflected in the interview record 405 generated by inputting the prompt 404 to the generative model 2A. Specifically, in the interview record 405, in response to the indication that the target interview is at the product proposal stage in the related information 402 and the proposed product is the foreign bond, as indicated by a dash-dotted box, it is clearly indicated that the proposed foreign bond is dollar dominated, and the explanation status about the risk such as the foreign exchange risk is indicated. In this way, in the example in FIG. 4, the interview record 405 in consideration of the related information 402 is generated.

### Generation Example 2 of Interview Record

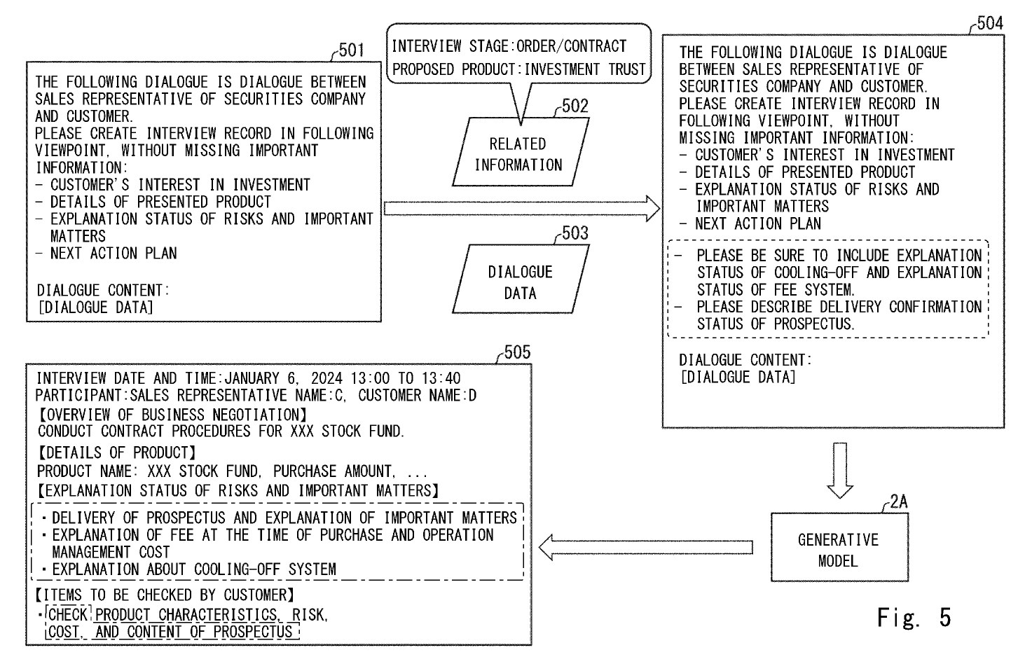

FIG. 5 is a diagram illustrating another generation example of the interview record by the information processing device 1A. In the example in FIG. 5, a prompt 504 is generated using a basic prompt 501, related information 502, and dialogue data 503. Then, the generated prompt 504 is input to the generative model 2A, and an interview record 505 is generated. Content of the basic prompt 501 is the same as the basic prompt 401 in FIG. 4.

The related information 502 illustrated in FIG. 5 indicates that the target interview is an interview at the order or contract stage and that the product proposed by the customer in the target interview is an investment trust. Such information can be estimated from the dialogue data or the like or may be input by the user via the input unit 13A or the like, as described above.

To the prompt 504 generated using the related information 502, a viewpoint to be noted at the time of the contract of the investment trust is added, as a new viewpoint that is not included in the basic prompt 501, as indicated by a dashed box in FIG. 5. Specifically, to the prompt 504, a viewpoint of constantly including an explanation status of cooling-off and a fee system and a viewpoint of describing a delivery confirmation status of a prospectus are added.

In this way, since the related information 502 is reflected in the prompt 504, the related information 502 is reflected in the interview record 505 generated by inputting the prompt 504 to the generative model 2A. Specifically, in the interview record 505, as indicated by a dash-dotted box, the explanation status of the cooling-off and the fee system and the delivery confirmation status of the prospectus are indicated. In this way, in the example in FIG. 5, as in the example in FIG. 4, the interview record 505 in consideration of the related information 502 is generated.

### Flow of Processing

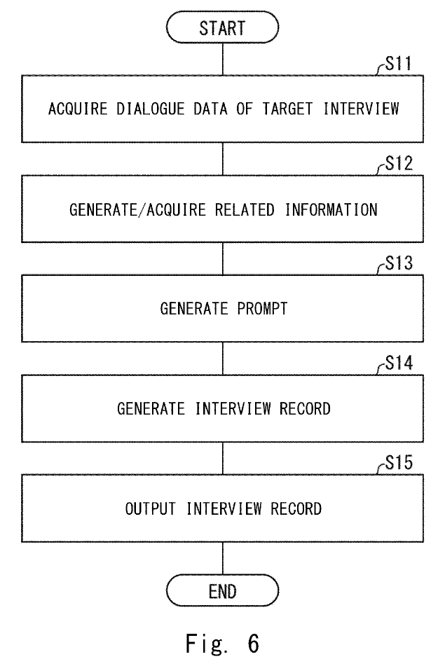

A flow of processing executed by the information processing device 1A will be described with reference to FIG. 6. FIG. 6 is a flowchart illustrating an example of the processing executed by the information processing device 1A. The flowchart in FIG. 6 includes each processing of an information processing method according to the present exemplary example embodiment.

In S11, the data acquisition unit 103A acquires the dialogue data indicating the content of the dialogue in the target interview. For example, the data acquisition unit 103A may acquire the text data generated by performing voice recognition on the voice data obtained by recording the dialogue in the target interview, as the dialogue data. In this case, the data acquisition unit 103A may execute voice recognition processing or may cause another device to execute the voice recognition processing and acquire text data generated by the voice recognition processing from the another device.

In S12, the related information generation unit 104A generates the related information regarding the target interview, using the dialogue data acquired in S11. In a case where the target interview is the business negotiation, examples of the related information acquired in S12 include, for example, information regarding the customer (buyer), information regarding a product or a service to be sold, information indicating the stage of the interview, or the like. The related information may also be acquired by the data acquisition unit 103A, and in that case, the generation of the related information by the related information generation unit 104A may be omitted.

In S13 (prompt generation processing), the prompt generation unit 101A generates the prompt for instructing to generate the interview record, reflecting the related information, using the related information acquired or generated in S12. For example, the prompt generation unit 101A may generate the prompt by incorporating the related information into the basic prompt as illustrated in FIG. 4.

In S14 (generation control processing), the generation control unit 102A inputs the prompt generated in S13, to the generative model 2A that generates the interview record according to the input instruction and generates the interview record of the target interview.

In S15, the output control unit 105A causes the output device to output the interview record generated in S14. Accordingly, the processing in FIG. 6 is ended. It is not essential to output the interview record. For example, the generated interview record may be stored in a storage device such as the storage unit 11A, and the processing may end.

As described above, in the information processing method executed by the information processing device 1A, the related information regarding the target interview is generated or acquired, and the prompt is generated using the generated or acquired related information. As a result, in a case where new related information is acquired for the target interview, it is possible to generate an interview record reflecting the new related information. In a case where the stage of the interview advances or in a case where a task of the interview changes, it is possible to generate an interview record reflecting the change in the stage or the task. In this way, one of characteristics of the information processing device 1A and the information processing method according to the present exemplary example embodiment is that it is possible to generate an optimal interview record according to a situation or an application, by dynamically generating or adjusting the prompt.

### Typical Use Case

As a typical use case of the information processing device 1A in the present example embodiment, generation of an interview record in a business negotiation between a sales representative of a securities company and a customer will be described.

In a case where the sales representative negotiates with the customer, the data acquisition unit 103A of the information processing device 1A performs voice recognition on a dialogue in the business negotiation and acquires text data. The data acquisition unit 103A may acquire the text data subjected to voice recognition by a device other than the information processing device 1A. This text data is sent to the related information generation unit 104A as the dialogue data.

The related information generation unit 104A generates related information indicating a progress status or a purpose of the business negotiation, a type of the proposed financial product, or the like, by analyzing the dialogue data. For example, if the dialogue data includes an utterance “I will explain the yield of the foreign bonds”, the related information generation unit 104A estimates that the interview is at the product proposal stage and the proposed product is the foreign bond.

Moreover, the related information generation unit 104A may estimate an investment experience and a financial knowledge level of the customer from the dialogue data. For example, in a case where there are few technical terms in an utterance of the customer and many basic questions, the related information generation unit 104A estimates that the customer is a customer having only limited investment experience. The related information generated in this way is sent to the prompt generation unit 101A.

The prompt generation unit 101A generates a prompt for generating the interview record based on the related information. For example, in a case where it is estimated that the customer has only limited investment experience and the related information indicating that the customer has only the limited investment experience is generated, the prompt generation unit 101A generates a prompt for instructing to explain a technical term using easy words. For example, in a case where the related information indicating that the foreign bond is proposed in the target interview is generated, the prompt generation unit 101A may include a sentence for instructing to always describe the explanation status of the foreign exchange risk, in the prompt.

The generation control unit 102A inputs this prompt to the generative model that is a machine-learned model and generates the interview record. In the generated interview record, main points of product explanation, a risk explanation execution status, a comprehension level and a reaction of the customer, a next action plan, or the like are described as appropriate expression according to a knowledge level of the customer. This interview record is utilized for review of proposal content by the sales representative, compliance check, preparation for a next business negotiation, or the like.

In this way, the information processing device 1A according to the present example embodiment can automatically generate the interview record useful in practice, in consideration of context of the business negotiation and characteristics of the participant, instead of simply writing the dialogue.

### Modified Examples

An executing entity of each processing described in the above-described exemplary example embodiments is optional, and is not limited to the above-described examples. For example, a system having functions similar to those of the information processing devices 1 and 1A can be constructed by a plurality of devices capable of communicating with each other. The executing entity of each processing illustrated in the flowchart in FIG. 6 may be one device (may be rephrased as a processor) or a plurality of devices (may be similarly rephrased as processors).

### Example of Implementation by Software

Some or all of the functions of the information processing devices 1 and 1A (hereinafter, also referred to as “each of the above devices”) may be implemented by hardware such as an integrated circuit (IC chip) or may be implemented by software.

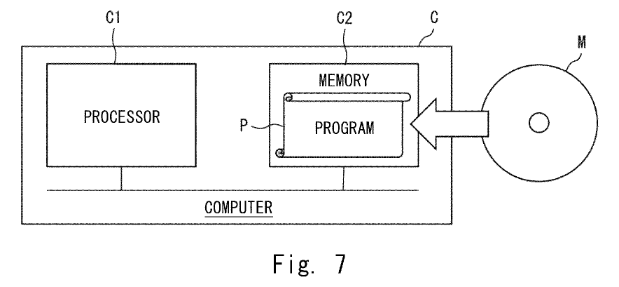

In the latter case, each of the above devices is implemented by, for example, a computer that executes commands of a program, that is software for implementing each function. An example of such a computer (hereinafter, referred to as computer C) is illustrated in FIG. 7. FIG. 7 is a block diagram illustrating a hardware configuration of the computer C functioning as each of the above devices.

The computer C includes at least one processor C1 and at least one memory C2. A program (information processing program) P for operating the computer C as each of the above devices is recorded in the memory C2. In the computer C, by the processor C1 reading the program P from the memory C2 and executing the program P, each function of each of the above devices is achieved.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output apparatuses such as a keyboard, a mouse, a display, or a printer.

The program P can be recorded on a non-transitory tangible recording medium M readable by the computer C. Examples of such a recording medium M may include a tape, a disk, a card, a semiconductor memory, a programmable logic circuit, or the like. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Notes

The present disclosure includes the techniques described in the following Supplementary Notes. However, the present disclosure is not limited to the techniques described in the following Supplementary Notes, and various modifications may be made within the scope described in the claims.

### Supplementary Note A1

An information processing device including: prompt generation means for generating a prompt for instructing to generate an interview record, reflecting related information, using the related information regarding a target interview of which the interview record is generated; and generation control means for inputting the prompt to a generative model that generates the interview record according to an input instruction and causing the generative model to generate the interview record of the target interview.

### Supplementary Note A2

The information processing device according to supplementary note A1, further including related information generation means for generating the related information using dialogue data indicating content of a dialogue in the target interview.

### Supplementary Note A3

The information processing device according to supplementary note A2, in which the target interview is one of a series of interviews conducted a plurality of times, and the related information generation means estimates which one of the series of interviews the target interview corresponds to from the dialogue data and generates related information indicating a result of the estimation.

### Supplementary Note A4

The information processing device according to supplementary note A2 or A3, in which the related information generation means estimates a purpose of the target interview from the dialogue data and generates related information indicating a result of the estimation.

### Supplementary Note A5

The information processing device according to any one of supplementary notes A1 to A4, in which the prompt generation means generates a template of the prompt using the related information, and generates a prompt using the generated template.

### Supplementary Note A6

The information processing device according to any one of supplementary notes A1 to A5, in which the prompt generation means generates a prompt for instructing to generate an interview record in a style suitable for an attribute, using the related information indicating the attribute of a participant of the target interview.

### Supplementary Note A7

The information processing device according to any one of supplementary notes A1 to A6, in which the prompt generation means generates a prompt for instructing to generate an interview record indicating an execution status of a predetermined response to be made in a case where a product or a service is recommended, using the related information indicating the product or the service recommended by a seller side in the target interview.

### Supplementary Note A8

The information processing device according to any one of supplementary notes A1 to A7, in which the prompt generation means generates a prompt for instructing to generate an interview record suitable for an application, using the related information indicating the application of the interview record.

### Supplementary Note B1

An information processing method in which at least one processor executes: prompt generation processing for generating a prompt for instructing to generate an interview record, reflecting related information, using the related information regarding a target interview of which the interview record is generated; and generation control processing for inputting the prompt to a generative model that generates the interview record according to an input instruction and causing the generative model to generate the interview record of the target interview.

### Supplementary Note B2

The information processing method according to supplementary note B1, further including related information generation processing for generating the related information using dialogue data indicating content of a dialogue in the target interview, by the at least one processor.

### Supplementary Note B3

The information processing method according to supplementary note B2, in which the target interview is one of a series of interviews conducted a plurality of times, and in the related information generation processing, the at least one processor estimates which one of the series of interviews the target interview corresponds to from the dialogue data and generates related information indicating a result of the estimation.

### Supplementary Note B4

The information processing method according to supplementary note B2 or B3, in which, in the related information generation processing, the at least one processor estimates a purpose of the target interview from the dialogue data and generates related information indicating a result of the estimation.

### Supplementary Note B5

The information processing method according to any one of supplementary notes B1 to B4, in which, in the prompt generation processing, the at least one processor generates a template of the prompt using the related information, and generates a prompt using the generated template.

### Supplementary Note B6

The information processing method according to any one of supplementary notes B1 to B5, in which, in the prompt generation processing, the at least one processor generates a prompt for instructing to generate an interview record in a style suitable for an attribute, using the related information indicating the attribute of a participant of the target interview.

### Supplementary Note B7

The information processing method according to any one of supplementary notes B1 to B6, in which, in the prompt generation processing, the at least one processor generates a prompt for instructing to generate an interview record indicating an execution status of a predetermined response to be made in a case where a product or a service is recommended, using the related information indicating the product or the service recommended by a seller side in the target interview.

### Supplementary Note B8

The information processing method according to any one of supplementary notes B1 to B7, in which, in the prompt generation processing, the at least one processor generates a prompt for instructing to generate an interview record suitable for an application, using the related information indicating the application of the interview record.

### Supplementary Note C1

An information processing program for causing a computer to function as: prompt generation means for generating a prompt for instructing to generate an interview record, reflecting related information, using the related information regarding a target interview of which the interview record is generated; and generation control means for inputting the prompt to a generative model that generates the interview record according to an input instruction and causing the generative model to generate the interview record of the target interview.

### Supplementary Note C2

The information processing program according to supplementary note C1, for causing the computer to function as related information generation means for generating the related information using dialogue data indicating content of a dialogue in the target interview.

### Supplementary Note C3

The information processing program according to supplementary note C2, in which the target interview is one of a series of interviews conducted a plurality of times, and the related information generation means estimates which one of the series of interviews the target interview corresponds to from the dialogue data and generates related information indicating a result of the estimation.

### Supplementary Note C4

The information processing program according to supplementary note C2 or C3, in which the related information generation means estimates a purpose of the target interview from the dialogue data and generates related information indicating a result of the estimation.

### Supplementary Note C5

The information processing program according to any one of supplementary notes C1 to C4, in which the prompt generation means generates a template of the prompt using the related information, and generates a prompt using the generated template.

### Supplementary Note C6

The information processing program according to any one of supplementary notes C1 to C5, in which the prompt generation means generates a prompt for instructing to generate an interview record in a style suitable for an attribute, using the related information indicating the attribute of a participant of the target interview.

### Supplementary Note C7

The information processing program according to any one of supplementary notes C1 to C6, in which the prompt generation means generates a prompt for instructing to generate an interview record indicating an execution status of a predetermined response to be made in a case where a product or a service is recommended, using the related information indicating the product or the service recommended by a seller side in the target interview.

### Supplementary Note C8

The information processing program according to any one of supplementary notes C1 to C7, in which the prompt generation means generates a prompt for instructing to generate an interview record suitable for an application, using the related information indicating the application of the interview record.

### Supplementary Note D1

An information processing device including: at least one processor, in which the at least one processor executes prompt generation processing for generating a prompt for instructing to generate an interview record, reflecting related information, using the related information regarding a target interview of which the interview record is generated and generation control processing for inputting the prompt to a generative model that generates the interview record according to an input instruction and causing the generative model to generate the interview record of the target interview. The information processing device may further include a memory. The memory may store a program for causing the at least one processor to execute each of the processing.

### Supplementary Note D2

The information processing device according to supplementary note D1, in which the at least one processor executes related information generation processing for generating the related information using dialogue data indicating content of a dialogue in the target interview.

### Supplementary Note D3

The information processing device according to supplementary note D2, in which the target interview is one of a series of interviews conducted a plurality of times, and in the related information generation processing, the at least one processor estimates which one of the series of interviews the target interview corresponds to from the dialogue data and generates related information indicating a result of the estimation.

### Supplementary Note D4

The information processing device according to supplementary note D2 or D3, in which, in the related information generation processing, the at least one processor estimates a purpose of the target interview from the dialogue data and generates related information indicating a result of the estimation.

### Supplementary Note D5

The information processing device according to any one of supplementary notes D1 to D4, in which, in the prompt generation processing, the at least one processor generates a template of the prompt using the related information, and generates a prompt using the generated template.

### Supplementary Note D6

The information processing device according to any one of supplementary notes D1 to D5, in which, in the prompt generation processing, the at least one processor generates a prompt for instructing to generate an interview record in a style suitable for an attribute, using the related information indicating the attribute of a participant of the target interview.

### Supplementary Note D7

The information processing device according to any one of supplementary notes D1 to D6, in which, in the prompt generation processing, the at least one processor generates a prompt for instructing to generate an interview record indicating an execution status of a predetermined response to be made in a case where a product or a service is recommended, using the related information indicating the product or the service recommended by a seller side in the target interview.

### Supplementary Note D8

The information processing device according to any one of supplementary notes D1 to D7, in which, in the prompt generation processing, the at least one processor generates a prompt for instructing to generate an interview record suitable for an application, using the related information indicating the application of the interview record.

### Supplementary Note E

A non-transitory recording medium recording an information processing program for causing a computer to execute: prompt generation processing for generating a prompt for instructing to generate an interview record, reflecting related information, using the related information regarding a target interview of which the interview record is generated; and generation control processing for inputting the prompt to a generative model that generates the interview record according to an input instruction and causing the generative model to generate the interview record of the target interview.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing device comprising:
at least one memory storing instructions; and
at least one processor configured to execute the instructions to:
generate a prompt for instructing to generate an interview record, reflecting related information, using the related information regarding a target interview of which the interview record is generated; and
input the prompt to a generative model that generates the interview record according to an input instruction and cause the generative model to generate the interview record of the target interview.

2. The information processing device according to claim 1, wherein the at least one processor is further configured to execute the instructions to generate the related information using dialogue data indicating content of a dialogue in the target interview.

3. The information processing device according to claim 2, wherein
the target interview is one of a series of interviews conducted a plurality of times, and
the at least one processor is further configured to execute the instructions to estimate which one of the series of interviews the target interview corresponds to from the dialogue data and generate related information indicating a result of the estimation.

4. The information processing device according to claim 2, wherein the at least one processor is further configured to execute the instructions to estimate a purpose of the target interview from the dialogue data and generate related information indicating a result of the estimation.

5. The information processing device according to claim 1, wherein the at least one processor is further configured to execute the instructions to generate a template of the prompt using the related information, and generate a prompt using the generated template.

6. The information processing device according to claim 1, wherein the at least one processor is further configured to execute the instructions to generate a prompt for instructing to generate an interview record in a style suitable for an attribute, using the related information indicating the attribute of a participant of the target interview.

7. The information processing device according to claim 1, wherein the at least one processor is further configured to execute the instructions to generate a prompt for instructing to generate an interview record indicating an execution status of a predetermined response to be made in a case where a product or a service is recommended, using the related information indicating the product or the service recommended by a seller side in the target interview.

8. The information processing device according to claim 1, wherein the at least one processor is further configured to execute the instructions to generate a prompt for instructing to generate an interview record suitable for an application, using the related information indicating the application of the interview record.

9. An information processing method wherein
at least one processor executes:
prompt generation processing for generating a prompt for instructing to generate an interview record, reflecting related information, using the related information regarding a target interview of which the interview record is generated; and
generation control processing for inputting the prompt to a generative model that generates the interview record according to an input instruction and causing the generative model to generate the interview record of the target interview.

10. A non-transitory computer readable medium storing an information processing program for causing a computer to:
generate a prompt for instructing to generate an interview record, reflecting related information, using the related information regarding a target interview of which the interview record is generated; and
input the prompt to a generative model that generates the interview record according to an input instruction and cause the generative model to generate the interview record of the target interview.
